(19) United States
(12) Patent Application Publication
(10) Pub. No.: US 2022/0407045 A1
(43) Pub. Date: Dec. 22, 2022

(54) MEMBER FOR POWER STORAGE DEVICE, ALL-SOLID-STATE BATTERY, AND METHOD FOR MANUFACTURING MEMBER FOR POWER STORAGE DEVICE

(71) Applicant: NIPPON ELECTRIC GLASS CO., LTD., Otsu-shi, Shiga (JP)

(72) Inventors: Ayumu TANAKA, Otsu-shi (JP); Junichi IKEJIRI, Otsu-shi (JP); Kei TSUNODA, Otsu-shi (JP); Hideo YAMAUCHI, Otsu-shi (JP)

(21) Appl. No.: 17/775,407

(22) PCT Filed: Dec. 7, 2020
(86) PCT No.: PCT/JP2020/045384

§ 371 Date: May 9, 2022

(30) Foreign Application Priority Data
Dec. 18, 2019 (JP) 2019-228143
Sep. 29, 2020 (JP) 2020-163045

(51) Int. Cl. H01M 4/04

(52) U.S. Cl. CPC H01M 4/0471; H01M 2004/021

(57) ABSTRACT

Provided is a member for a power storage device that, even when the amount of electrode active material supported is increased, enables charge and discharge and thus achieves a high capacity. A member 6 for a power storage device includes: a solid electrolyte layer 1; and an electrode layer 2 provided on the solid electrolyte layer 1 and made of a sintered body of an electrode material layer 2A containing an electrode active material precursor powder having an average particle diameter of not less than 0.01 μm and less than 0.7 μm.

### TECHNICAL FIELD

The present invention relates to members for power storage devices, all-solid-state batteries, and methods for manufacturing members for power storage devices.

### BACKGROUND ART

Lithium-ion secondary batteries have secured their place as high-capacity and light-weight power sources essential for mobile devices, electric vehicles, and so on. However, current lithium-ion secondary batteries employ as their electrolytes, mainly, combustible organic electrolytic solutions, which raises concerns about the risk of burning or the like. As a solution to this problem, developments of lithium-ion all-solid-state batteries using a solid electrolyte instead of an organic electrolytic solution have been promoted (see, for example, Patent Literature 1). Furthermore, because, as for lithium, there are concerns about such issues as global rise in raw material costs, studies have recently been conducted on sodium-ion all-solid-state secondary batteries as alternatives to lithium-ion all-solid-state secondary batteries. Patent Literature 2 discloses positive-electrode active materials represented by Naₓ(Fe₁₋ₐMₐ)_{y}P2O_{z} (where M represents at least one transition metal element selected from the group consisting of Cr, Mn, Co, and Ni, 1.2×2.8, 0.95≤y≤1.6, 0≤a≤0.9, and 7≤z≤8). According to Patent Literature 2, a positive electrode layer containing a positive-electrode active material described above is formed by applying a slurry containing an amorphous glass powder to one of the surfaces of a solid electrolyte, drying it, and then firing it.

### CITATION LIST

### Patent Literature

[PTL 1]
JP-A-H05-205741
[PTL 2]
WO2016/084573

### SUMMARY OF INVENTION

### Technical Problem

Secondary batteries serving as power sources for electric vehicles or the like are required to have high energy density in order to increase the vehicle cruising distance. In order to have high energy density, a secondary battery needs to achieve a high capacity by increasing the amount of electrode active material supported in an electrode layer or increasing the thickness of the electrode layer. However, in such a method, as in Patent Literature 2, of forming an electrode material layer on a solid electrolyte layer and firing it, increasing the amount of electrode active material supported or increasing the thickness of the electrode material layer may cause a positive electrode layer obtained by firing to peel off from the solid electrolyte layer. In this case, there arises a problem that the interface for ion conduction is lost and, thus, the battery does not work.

An object of the present invention is to provide a member for a power storage device, an all-solid-state battery, and a method for manufacturing a member for a power storage device all of which, even when the amount of electrode active material supported is increased, enable charge and discharge and thus achieve a high capacity.

### Solution to Problem

A member for a power storage device according to the present invention includes: a solid electrolyte layer; and an electrode layer provided on the solid electrolyte layer and made of a sintered body of an electrode material layer containing an electrode active material precursor powder having an average particle diameter of not less than 0.01 μm and less than 0.7 μm.

In the present invention, the electrode layer preferably has a thickness of 20 μm or more.

In the present invention, an amount of electrode active material supported in the electrode layer is preferably 3 mg/cm² or more.

An all-solid-state battery according to the present invention includes one of the above-described embodiments of the member for a power storage device.

A method for manufacturing a member for a power storage device according to the present invention includes: a forming step of forming an electrode material layer containing an electrode active material precursor powder on a solid electrolyte layer; and a firing step of firing the electrode material layer while applying pressure to the electrode material layer.

In the present invention, it is preferred that the electrode material layer has a first principal surface facing the solid electrolyte layer and a second principal surface opposed to the first principal surface and, in the firing step, the electrode material layer is fired while pressure is applied to the entire second principal surface.

In the present invention, in the firing step, a pressure of 1 kPa or more is preferably applied to the electrode material layer.

In the present invention, the electrode active material precursor powder preferably has an average particle diameter of not less than 0.01 μm and less than 0.7 μm.

In the present invention, the electrode active material precursor powder is preferably an amorphous oxide material.

In the present invention, the electrode material layer is preferably a positive-electrode material layer.

In the present invention, the electrode active material precursor powder preferably contains, in terms of % by mole of oxides, 25% to 55% Na₂O, 10% to 30% Fe₂O₃+Cr₂O₃+MnO+CoO+NiO, and 25% to 55% P₂O₅.

### Advantageous Effects of Invention

The present invention enables provision of a member for a power storage device, an all-solid-state battery, and a method for manufacturing a member for a power storage device all of which, even when the amount of electrode active material supported is increased, enable charge and discharge and thus achieve a high capacity.

### BRIEF DESCRIPTION OF DRAWINGS

FIGS. 1(a) to 1(c) are schematic cross-sectional views for illustrating a method for manufacturing a member for a power storage device according to one embodiment of the present invention.

FIG. 2 is a schematic cross-sectional view showing an all-solid-state battery according to one embodiment of the present invention.

FIG. 3 is a photograph in plan view of a positive electrode layer obtained in Example 5.

FIG. 4 is a photograph in plan view of a positive electrode layer obtained in Reference Example 2.

### DESCRIPTION OF EMBODIMENTS

Hereinafter, a description will be given of preferred embodiments. However, the following embodiments are merely illustrative and the present invention is not intended to be limited to the following embodiments. Throughout the drawings, members having substantially the same functions may be referred to by the same reference characters.

[Manufacturing Methods of Member for Power Storage Device and All-Solid-State Battery]

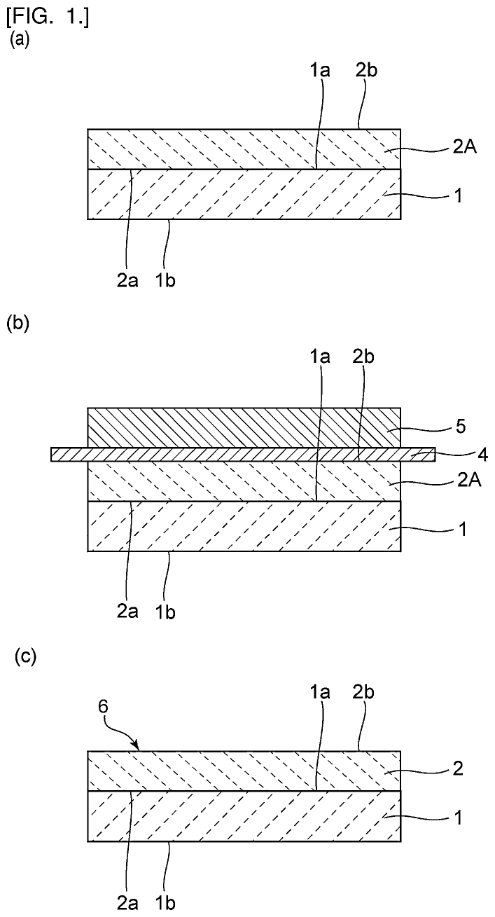

FIGS. 1(a) to 1(c) are schematic cross-sectional views for illustrating a method for manufacturing a member for a power storage device according to one embodiment of the present invention. FIG. 2 is a schematic cross-sectional view showing an all-solid-state battery according to one embodiment of the present invention.

In the manufacturing method according to this embodiment, first, a positive-electrode material layer 2A containing a positive-electrode active material precursor powder is formed on a first principal surface 1a of a solid electrolyte layer 1 as shown in FIG. 1(a). Next, as shown in FIG. 1(b), the positive-electrode material layer 2A is fired while pressure is applied thereto. As a result, a positive electrode layer 2 shown in FIG. 1(c) is formed on the first principal surface 1a of the solid electrolyte layer 1, thus obtaining a member 6 for a power storage device. Next, a negative electrode layer 3 shown in FIG. 2 is formed on a second principal surface 1b of the solid electrolyte layer 1. As a result, an all-solid-state battery 10 can be obtained.

In the manufacturing method according to this embodiment, since the positive-electrode material layer 2A formed on the solid electrolyte layer 1 is fired while pressure is applied thereto, it is possible to manufacture a member 6 for a power storage device that, even when the amount of electrode active material supported is increased, can be charged and discharged and thus can achieve a high capacity in the all-solid-state battery 10 serving as a power storage device. The reason for this can be explained as follows.

In a conventional method of forming a positive-electrode material layer containing a positive-electrode active material precursor powder on a solid electrolyte layer and firing it, a positive electrode layer obtained by the firing may peel off from the solid electrolyte layer. The reason for this can be attributed to the fact that when the positive-electrode active material precursor powder used is, for example, an amorphous material, volume contraction is likely to occur due to crystallization during the firing. Particularly, when the amount of electrode active material supported is increased or the thickness of the positive electrode layer is increased, the above peel-off problem tends to be significant.

Furthermore, secondary batteries serving as power sources for electric vehicles or the like are required to have high output characteristics in order to drive the motor. When the positive-electrode active material precursor powder is made finer to obtain higher output, a denser positive electrode layer can be obtained, in which case the specific surface area of the positive-electrode active material precursor powder becomes larger. This involves increasing the additive amount of binder in making the positive-electrode active material precursor powder into a paste. However, the binder volatilizes during firing to increase the amount of voids in the positive-electrode material layer, which makes it more likely that volume contraction of the positive-electrode material layer occurs. As a result, the peel-off of the positive electrode layer from the solid electrolyte layer becomes more likely to occur.

In contrast, since, in the manufacturing method according to this embodiment, the positive-electrode material layer 2A formed on the solid electrolyte layer 1 is fired while pressure is applied thereto, the contraction of the positive-electrode material layer 2A in the planar direction can be suppressed, so that the adhesiveness between the positive electrode layer 2 obtained by the firing and the solid electrolyte layer 1 can be increased. Therefore, particularly, even when the amount of electrode active material supported is increased or the thickness of the positive electrode material layer 2A is increased, the positive electrode layer 2 obtained by the firing is less likely to peel off from the solid electrolyte layer 1. Since, as just described, the positive electrode layer 2 is less likely to peel off from the solid electrolyte layer 1, the interface for ion conduction is less likely to be lost and, thus, a member 6 for a power storage device and an all-solid-state battery 10 which can be charged and discharged with high output power can be obtained. In addition, since the amount of positive-electrode active material supported and the thickness of the positive-electrode material layer 2A can be increased, a high capacity can be achieved and, thus, the energy density of the all-solid-state battery can be increased.

Hereinafter, a detailed description will be given of, as an example, each manufacturing step for an all-solid-state sodium-ion secondary battery in which a material having sodium-ion conductivity is used.

(Step of Forming Positive-Electrode Material Layer)

A positive-electrode material layer 2A can be obtained by applying a slurry containing a positive-electrode active material precursor powder onto a first principal surface 1a of a solid electrolyte layer 1 and drying the slurry. The slurry may contain a solid electrolyte powder and/or a conductive agent. Furthermore, the slurry may contain, as necessary, a binder, a plasticizer, a solvent, and/or so on.

Positive-Electrode Active Material Precursor Powder:

The positive-electrode active material precursor powder is preferably made of an amorphous oxide material that generates positive-electrode active material crystals when subjected to firing. When subjected to firing, the amorphous oxide material not only generates positive-electrode active material crystals, but also can be softened and fluidified to forma denser positive electrode layer 2. As a result, an ion-conducting path is formed better, which is favorable. In the present invention, the term “amorphous oxide material” is not limited to a fully amorphous oxide material and includes those partly containing crystals (for example, those having a crystallinity of 10% or less).

The positive-electrode active material precursor powder preferably contains, in terms of % by mole of the following oxides, 25% to 55% Na₂O, 10% to 30% Fe₂O₃+Cr₂O₃+MnO+CoO+NiO, and 25% to 55% P₂O₅. The reasons why the composition is limited as just described will be described below. In the following description of the respective contents of the components, “%” refers to “% by mole” unless otherwise stated.

Na₂O is a main component of the positive-electrode active material crystals represented by the general formula NaₓM_{y}P₂O_{z} (where M represents at least one transition metal element selected from Fe, Cr, Mn, Co and Ni, 1.20≤x≤2.10, and 0.95≤y≤1.60). The content of Na₂O is preferably 25% to 55% and more preferably 30% to 50%. If the content of Na₂O is too small or too large, the charge and discharge capacities tend to decrease.

Fe₂O₃, Cr₂O₃, MnO, CoO, and NiO are also main components of the positive-electrode active material crystals represented by the general formula NaₓM_{y}P₂O_{z}. The content of Fe₂O₃+Cr₂O₃+MnO+CoO+NiO is preferably 10% to 30% and more preferably 15% to 25%. If the content of Fe₂O₃+Cr₂O₃+MnO+CoO+NiO is too small, the charge and discharge capacities tend to decrease. On the other hand, if the content of Fe₂O₃+Cr₂O₃+MnO+CoO+NiO is too large, undesirable crystals, such as Fe₂O₃, Cr₂O₃, MnO, CoO or NiO, are likely to precipitate. In order to increase the cycle characteristics, Fe₂O₃ is preferably positively contained in the positive-electrode active material precursor powder. The content of Fe₂O₃ is preferably 1% to 30%, more preferably 5% to 30%, still more preferably 10% to 30%, and particularly preferably 15% to 25%. The content of each component of Cr₂O₃, MnO, CoO, and NiO is preferably 0% to 30%, more preferably 10% to 30%, and still more preferably 15% to 25%. In containing at least two components selected from. Fe₂O₃, Cr₂O₃, MnO, CoO, and NiO in the positive-electrode active material precursor powder, the total content of them is preferably 10% to 30% and more preferably 15% to 25%.

P₂O₅ is also a main component of the positive-electrode active material crystals represented by the general formula NaₓM_{y}P₂O_{z}. The content of P₂O₅ is preferably 25% to 55% and more preferably 30% to 50%. If the content of P₂O₅ is too small or too large, the charge and discharge capacities tend to decrease.

The positive-electrode active material precursor powder may contain, in addition to the above components, V₂O₅, Nb₂O₅, MgO, Al₂O₃, TiO₂, ZrO₂ or Sc₂O₃. These components have the effect of increasing the conductivity (electronic conductivity), which facilitates the enhancement of the rapid charge and discharge characteristics of the positive-electrode active material. The total content of these components is preferably 0% to 25% and more preferably 0.2% to 10%. If the content of these components is too large, heterogeneous crystals not contributing to the battery characteristics are generated, so that the charge and discharge capacities are likely to decrease.

Aside from the above components, the positive-electrode active material precursor powder may contain SiO₂, B₂O₃, GeO₂, Ga₂O₃, Sb₂O₃ or Bi₂O₃. When containing these components, a positive-electrode active material precursor powder having an increased glass formation ability and being homogeneous is likely to be obtained. The total content of these components is preferably 0% to 25% and more preferably 0.2% to 10%. Because these components do not contribute to the battery characteristics, an excessively large content of them leads to a tendency to decrease the charge and discharge capacities.

The positive-electrode active material precursor powder is preferably made by melting a raw material batch and forming the melt into a shape. This method is preferred because an amorphous positive-electrode active material precursor powder having excellent homogeneity can be easily obtained. Specifically, the positive-electrode active material precursor powder can be produced in the following manner.

First, raw materials are formulated to give a desired composition, thus obtaining a raw material batch. Next, the obtained raw material batch is melted. It is sufficient for the melting temperature to be appropriately adjusted so that the raw material batch can be homogeneously melted. For example, the melting temperature is preferably 800° C. or higher and more preferably 900° C. or higher. The upper limit of the melting temperature is not particularly limited, but an excessively high melting temperature leads to energy loss or evaporation of the sodium component and so on. Therefore, the melting temperature is preferably not higher than 1500° C. and more preferably not higher than 1400° C.

Next, the obtained melt is formed into a shape. The method for forming the melt into a shape is not particularly limited. For example, the melt may be formed into a film with rapid cooling by pouring the melt between a pair of cooling rolls or formed into an ingot by casting the melt into a mold.

Subsequently, the obtained formed body is ground to obtain a positive-electrode active material precursor powder. The average particle diameter of the positive-electrode active material precursor powder is preferably not less than 0.01 μm and less than 0.7 μm, more preferably 0.03 μm to 0.6 μm both inclusive, still more preferably 0.05 μm to 0.6 μm both inclusive, and particularly preferably 0.1 μm to 0.5 μm both inclusive. If the average particle diameter of the positive-electrode active material precursor powder is too small, the cohesion between the powder particles increases when the positive-electrode active material precursor powder is used in paste form, so that it is less likely to be dispersed into the paste. In addition, in mixing the positive-electrode active material precursor powder with a solid electrolyte powder or the like, it is difficult to uniformly disperse the positive-electrode active material precursor powder into the mixture, so that the internal resistance increases. Therefore, the output characteristics decrease and, thus, the charge and discharge capacities may decrease. On the other hand, if the average particle diameter of the positive-electrode active material precursor powder is too large, the crystallization temperature tends to be high. In addition, the amount of ions and electrons diffusing per unit surface area of the positive electrode material decreases, so that the internal resistance increases. Therefore, the output characteristics decreases and, as a result, the charge and discharge capacities tend to decrease. Furthermore, in mixing the positive-electrode active material precursor powder with a solid electrolyte powder, the adhesiveness between the positive-electrode active material precursor powder and the solid electrolyte powder decreases. Therefore, the mechanical strength of the positive electrode layer 2 decreases and, as a result, the charge and discharge capacities tend to decrease. Alternatively, the adhesiveness between the positive electrode layer 2 and the solid electrolyte layer 1 becomes poor, so that the positive electrode layer 2 may peel off from the solid electrolyte layer 1.

When the average particle diameter of the positive-electrode active material precursor powder is reduced, a dense positive electrode layer can be obtained, in which case the specific surface area of the positive-electrode active material precursor powder becomes larger. This involves increasing the additive amount of binder in making the positive-electrode active material precursor powder into a paste. However, the binder volatilizes during firing to increase the amount of voids in the positive-electrode material layer, which makes it more likely that volume contraction of the positive-electrode material layer occurs. As a result, the peel-off of the positive electrode layer from the solid electrolyte layer becomes more likely to occur. In the manufacturing method according to this embodiment, the positive-electrode material layer 2A formed on the solid electrolyte layer 1 is fired while pressure is applied thereto. Therefore, even when the average particle diameter of the positive-electrode active material precursor powder is reduced, the positive electrode layer 2 obtained by firing is less likely to peel off from the solid electrolyte layer 1.

In the present invention, the average particle diameter means D50 (a volume-based average particle diameter) and refers to a value measured by the laser diffraction/scattering method.

Solid Electrolyte Powder:

The solid electrolyte powder is a component that plays a role in conducting ions through the positive electrode layer 2 in the all-solid-state battery 10.

Examples of the solid electrolyte powder include beta-alumina and NASICON crystals both of which have excellent sodium ion-conductivity. Beta-alumina includes two types of crystals: β-alumina (theoretical composition formula: Na₂·11Al₂O₃) and β″-alumina (theoretical composition formula: Na₂O·5.3Al₂O₃). β″-alumina is a metastable material and is therefore generally used in a state in which Li₂O or MgO is added as a stabilizing agent thereto. β″-alumina has a higher sodium-ion conductivity than β-alumina. Therefore, β″-alumina alone or a mixture of β″-alumina and β-alumina is preferably used and Li₂O-stabilized β″-alumina (Na_{1.7} Li_{0.3}Al_{10.7}O₁₇) or MgO-stabilized β″-alumina ((Al_{10.32}Mg_{0.68}O₁₆) (Na_{1.68}O)) is more preferably used.

Examples of the NASICON crystal include Na₃Zr₂Si₂PO₁₂, Na_{3.2}Zr_{1.3}Si_{2.2}P_{0.7}O_{10.5}, Na₃Zr_{1.6}Ti_{0.4}Si₂PO₁₂, Na₃Hf₂Si₂PO₁₂, Na_{3.4}Zr_{0.9}Hf_{1.4}Al_{0.6}Si_{1.2}P_{1.8}O₁₂, Na₃Zr_{1.7}Nb_{0.24}Si₂PO₁₂, Na_{3.6}Ti_{0.2}Y_{0.7}Si_{2.8}O₉, Na_{3.12}Zr_{1.88}Y_{0.12}Si₂PO₁₂, Na_{3.12}Zr_{1.88}Y_{0.12}Si₂PO₁₂, and Na_{3.6}Zr_{0.13}Yb_{1.67}Si_{0.11}P_{2.9}O₁₂, and Na_{3.12}Zr_{1.88}Y_{0.12}Si₂PO₁₂ is particularly preferred because it has excellent sodium-ion conductivity.

The average particle diameter of the solid electrolyte powder is preferably 0.05 μm to 3 μm both inclusive, more preferably not less than 0.05 μm and less than 1.8 μm, still more preferably 0.05 μm to 1.5 μm both inclusive, particularly preferably 0.1 μm to 1.2 μm both inclusive, and most preferably 0.1 μm to 0.7 μm both inclusive. If the average particle diameter of the solid electrolyte powder is too small, not only the solid electrolyte powder becomes difficult to uniformly mix together with the positive-electrode active material precursor powder, but also may absorb moisture or become carbonated to decrease the ionic conductivity or may promote an excessive reaction with the positive-electrode active material precursor powder. As a result, the internal resistance of the positive-electrode material layer increases, so that the voltage characteristics and the charge and discharge capacities tend to decrease. On the other hand, if the average particle diameter of the solid electrolyte powder is too large, this significantly inhibits the softening and flow of the positive-electrode active material precursor powder, so that the resultant positive electrode layer 2 tends to have poor smoothness to decrease the mechanical strength and tends to increase the internal resistance.

When the average particle diameter of the solid electrolyte powder is reduced, a dense positive electrode layer can be obtained, in which case the specific surface area of the solid electrolyte powder becomes larger. This involves increasing the additive amount of binder in making the solid electrolyte powder into a paste. However, the binder volatilizes during firing to increase the amount of voids in the positive-electrode material layer, which makes it more likely that volume contraction of the positive-electrode material layer occurs. As a result, the peel-off of the positive electrode layer from the solid electrolyte layer becomes more likely to occur. In the manufacturing method according to this embodiment, the positive-electrode material layer 2A formed on the solid electrolyte layer 1 is fired while pressure is applied thereto. Therefore, even when the average particle diameter of the solid electrolyte powder is reduced, the positive electrode layer 2 obtained by firing is less likely to peel off from the solid electrolyte layer 1.

The solid electrolyte layer 1 is preferably made of the same material as the above-described solid electrolyte powder. The solid electrolyte layer 1 can be produced by mixing raw material powders, forming the mixed raw material powders into a shape, and then firing them. For example, the solid electrolyte layer 1 can be produced by making the raw material powders into a slurry, forming the slurry into a green sheet, and then firing the green sheet. Alternatively, the solid electrolyte layer 1 may be produced by the sol-gel method.

Conductive Agent:

The conductive agent is a component that forms a conducting path in the positive electrode material. For example, a conductive carbon can be used as the conductive agent. Preferred conductive carbons are powdered or fibrous conductive carbons, including highly conductive carbon blacks, such as acetylene black and Ketjenblack. In adding the conductive carbon, it is preferably added when the positive-electrode active material precursor powder is ground. The conductive carbon not only plays a role as a grinding aid to enable homogeneous mixture with the positive-electrode active material precursor powder, but also reduces excessive fusion of the positive-electrode active material precursor powder particles during the firing, so that the electrical conductivity is likely to be ensured and the rapid charge and discharge characteristics are likely to increase.

Binder:

The binder is a material for binding the source material components (source material component powders) together. Examples of the binder include: cellulose derivatives, such as carboxymethyl cellulose, hydroxypropylmethyl cellulose, hydroxypropyl cellulose, ethyl cellulose, hydroxyethyl cellulose, and hydroxymethyl cellulose, or water-soluble polymers, such as polyvinyl alcohol; thermosetting resins, such as thermosetting polyimide, phenolic resin, epoxy resin, urea resin, melamine resin, unsaturated polyester resin, and polyurethane; polycarbonate-based resins, such as polypropylene carbonate; and polyvinylidene fluoride.

Composition of Source Material:

A solid source material preferably contains, in terms of % by mass, 30% to 100% positive-electrode active material precursor powder, 0% to 70% solid electrolyte powder, and 0% to 20% conductive carbon, more preferably contains 44.5% to 94.5% positive-electrode active material precursor powder, 5% to 55% solid electrolyte powder, and 0.5% to 15% conductive carbon, and still more preferably contains 50% to 92% positive-electrode active material precursor powder, 7% to 50% solid electrolyte powder, and 1% to 10% conductive carbon. If the content of the positive-electrode active material precursor powder is too small, the amount of components that absorb or release sodium ions with charge and discharge in the positive electrode material becomes small, so that the charge and discharge capacities of the power storage device tend to decrease. If the content of the conductive carbon or the solid electrolyte powder is too large, the bindability of the positive-electrode material precursor powder decreases to increase the internal resistance and, therefore, the voltage characteristics and the charge and discharge capacities tend to decrease.

The content of the binder is, relative to 100 parts by mass of solid source material, preferably 1 part by mass to 50 parts by mass and more preferably 5 parts by mass to 40 parts by mass. If the content of the binder is too small, the solid source material has poor bindability. Therefore, when the positive-electrode material layer 2A is dried, it may cause cracks or may peel off from the solid electrolyte layer 1. If the content of the binder is too large, due to volatilization of the binder during firing as described previously, the amount of voids in the positive-electrode material layer 2A is likely to be high and, therefore, volume contraction is likely to occur. However, in the manufacturing method according to this embodiment, the positive-electrode material layer 2A formed on the solid electrolyte layer 1 is fired while pressure is applied thereto. Therefore, even when the content of the binder is large, the positive electrode layer 2 obtained by firing is less likely to peel off from the solid electrolyte layer 1.

In mixing the source material components, a mixer, such as a planetary centrifugal mixer or a tumbler mixer, or a general grinder, such as a mortar, a mortar mixer, a ball mill, an attritor, a vibrating ball mill, a satellite ball mill, a planetary ball mill, a jet mill or a bead mill, can be used.

The drying temperature of the slurry is not particularly limited, but it may be, for example, not lower than 30° C. and not higher than 100° C. The drying time for the slurry is not particularly limited, but it may be, for example, not less than 10 minutes and not more than 600 minutes.

(Firing Step)

In the firing step, the positive-electrode material layer 2A formed on the solid electrolyte layer 1 is fired while pressure is applied thereto. In this embodiment, as shown in FIG. 1(b), a carbon sheet 4 is placed on the second principal surface 2b of the positive-electrode material layer 2A and a weight 5 is further placed on the carbon sheet 4. Thus, the positive-electrode material layer 2A is fired while pressure is applied thereto. The first principal surface 2a of the positive-electrode material layer 2A is a principal surface facing the solid electrolyte layer 1, whereas the second principal surface 2b is a principal surface opposed to the first principal surface 2a.

In this embodiment, pressure is applied to the entire second principal surface 2b of the positive-electrode material layer 2A. In the present invention, pressure is preferably applied to the entire second principal surface 2b, but it is sufficient to apply pressure to at least part of the second principal surface 2b. The area of the second principal surface 2b to which pressure is applied is not particularly limited.

The pressure to be applied to the positive-electrode material layer 2A is preferably 1 kPa or more, more preferably 5 kPa or more, and still more preferably 10 kPa or more. In this case, the positive electrode layer 2 obtained by the firing is even less likely to peel off from the solid electrolyte layer 1. The upper limit of the pressure to be applied to the positive-electrode material layer 2A is not particularly limited, but it may be, for example, 100 MPa.

The atmosphere during the firing is preferably a reductive atmosphere. Examples of the reductive atmosphere include atmospheres containing at least one reducing gas selected from H₂, NH₃, CO, H₂S, and SiH₄. From the viewpoint of efficiently reducing Fe ions in the positive-electrode active material precursor powder from trivalent to divalent ions, the atmosphere preferably contains at least one selected from H₂, NH₃ and CO and more preferably contains H₂ gas. In using H₂ gas, an inert gas, such as N₂, is preferably mixed with H₂ gas for the purpose of reducing the risks of explosion and the like during the firing. Specifically, the reducing gas preferably contains, in terms of % by volume, 90% to 99.9% N₂ and 0.1% to 10% H₂, more preferably contains 90% to 99.5% N₂ and 0.5% to 10% H₂ and still more preferably contains 92% to 99% N₂ and 1 to 8% H₂.

The firing temperature (maximum temperature) is preferably 400° C. to 600° C., more preferably 410° C. to 580° C., still more preferably 420° C. to 575° C., particularly preferably 425° C. to 560° C., and most preferably 450° C. to 530° C. If the firing temperature is too low, the crystallization of the positive-electrode active material precursor powder becomes insufficient, so that a remaining amorphous phase serves as a high-resistance portion and, thus, the voltage characteristics and the charge and discharge capacities tend to decrease. On the other hand, if the firing temperature is too high, the positive-electrode active material precursor powder particles excessively fuse together and, thus, coarse particles are formed, so that the specific surface area of the positive-electrode active material tends to be small and the charge and discharge characteristics tend to decrease. In addition, the positive-electrode active material precursor powder and the solid electrolyte powder react with each other during the firing and, thus, crystals not contributing to charge and discharge (such as maricite NaFePO₄ crystals) precipitate, so that the charge and discharge capacities may decrease. Alternatively, elements contained in the positive-electrode active material precursor powder and elements contained in the solid electrolyte powder are mutually dispersed during the firing, so that a high-resistance layer is partially formed and, thus, the rate characteristics of the all-solid-state battery serving as a power storage device may decrease.

The firing time (the holding time at the maximum temperature during the firing) is preferably less than three hours, more preferably two hours or less, still more preferably an hour or less, particularly preferably 45 minutes or less, and most preferably 30 minutes or less. If the firing time is too long, the positive-electrode active material precursor powder particles excessively fuse together and, thus, coarse particles are likely to be formed, so that the specific surface area of the positive-electrode active material tends to be small and the charge and discharge characteristics tend to decrease. In addition, in the case of an all-solid-state battery, the positive-electrode active material precursor powder and the solid electrolyte powder react with each other during the firing and, thus, crystals not contributing to charge and discharge (such as maricite NaFePO₄ crystals) precipitate, so that the charge and discharge capacities may decrease. Alternatively, elements contained in the positive-electrode active material precursor powder and elements contained in the solid electrolyte powder are mutually dispersed during the firing, so that a high-resistance layer is partially formed and, thus, the rate characteristics of the all-solid-state battery may decrease. On the other hand, if the firing time is too short, the crystallization of the positive-electrode active material precursor powder becomes insufficient, so that a remaining amorphous phase serves as a high-resistance portion and, thus, the voltage characteristics and the charge and discharge capacities tend to decrease. Therefore, the firing time is preferably not less than one minute and more preferably not less than five minutes.

For the firing, an electric heating furnace, a rotary kiln, a microwave heating furnace, a high-frequency heating furnace or the like can be used.

(Step of Forming Negative Electrode Layer)

The negative electrode layer 3 can be produced, for example, using a slurry containing a negative-electrode active material precursor powder and, as necessary, a solid electrolyte powder and/or a conductive agent. As necessary, a binder, a plasticizer, a solvent, and/or so on are added to the slurry. The negative electrode layer 3 can be produced by applying the slurry onto a second principal surface 1b of the solid electrolyte layer 1, drying it, and then firing it. Alternatively, the negative electrode layer 3 may be produced by applying the slurry onto a base material made of PET (polyethylene terephthalate) or so on, drying the slurry to make a green sheet, and then firing the green sheet. Still alternatively, the negative electrode layer 3 may be made of metal, in which case the negative electrode layer 3 can be formed by sputtering, vapor evaporation or the like.

### OTHER EMBODIMENTS

Although the description in the above embodiment has been given of a method for manufacturing an all-solid-state sodium-ion secondary battery in which a material having sodium-ion conductivity is used, the present invention may be applied to a method for manufacturing any other all-solid-state battery, such as an all-solid-state lithium-ion secondary battery in which a material having lithium-ion conductivity is used.

In the above embodiment, firing during formation of the positive electrode layer 2 is performed along with the application of pressure. However, instead of this, firing during formation of the negative electrode layer 3 may be performed along with the application of pressure. Alternatively, both during formation of the positive electrode layer 2 and during formation of the negative electrode layer 3, firing may be performed along with the application of pressure. Still alternatively, both the positive electrode layer 2 and the negative electrode layer 3 may be fired at the same time.

As necessary, a current collector layer may be formed on each of the positive electrode layer 2 and the negative electrode layer 3.

The method for forming the current collector layer is not particularly limited and examples include physical vapor deposition methods, such as evaporation coating and sputtering, and chemical vapor deposition methods, such as thermal CVD, MOCVD, and plasma CVD. Other methods for forming the current collector layer include liquid-phase deposition methods, such as plating, the sol-gel method, and spin coating. However, the current collector layer is preferably formed on the positive electrode layer 2 or the negative electrode layer 3 by sputtering because excellent adhesiveness is provided.

The material for the current collector layer is not particularly limited, but metallic materials, such as aluminum, titanium, silver, copper, stainless steel or an alloy of any of them, can be used. These metallic materials may be used singly or in combination of two or more of them. The alloy of any of them means an alloy containing at least one of the above metals.

[All-Solid-State Battery]

As shown in FIG. 2, an all-solid-state battery 10 includes a solid electrolyte layer 1, a positive electrode layer 2, and a negative electrode layer 3. The solid electrolyte layer 1 has a first principal surface 1a and a second principal surface 1b opposed to each other. The positive electrode layer 2 is provided on the first principal surface 1a of the solid electrolyte layer 1. Thus, a member 6 for a power storage device is formed. Furthermore, the negative electrode layer 3 is provided on the second principal surface 1b of the solid electrolyte layer 1.

The positive electrode layer 2 is made of a sintered body of a positive-electrode material layer containing a positive-electrode active material precursor powder having an average particle diameter of not less than 0.01 μm and less than 0.7 μm. Therefore, a dense positive electrode layer 2 is formed. Thus, the energy density can be increased and, as a result, the all-solid-state battery 10 achieves a high capacity. For the rest, the same elements and materials as described in relation to the above-described manufacturing method can be used.

The type of the positive-electrode active material contained in the positive electrode layer 2 is not particularly limited and examples include: layered sodium transition metal oxide crystals, such as NaCrO₂, Na_{0.7}MnO₂, and NaFe_{0.2}Mn_{0.4}Ni_{0.4}O₂; sodium transition metal phosphate crystals containing Na, M (where M represents at least one transition metal element selected from Cr, Fe, Mn, Co, and Ni), P, and O, such as Na₂FeP₂O₇, NaFePO₄, and Na₃V₂(PO₄)₃; and like active material crystals.

Particularly, crystals containing Na, M, P, and O are preferred because they have high capacity and excellent chemical stability. Among them, preferred crystals are triclinic crystals belonging to space group P1 or P-1 and, particularly, crystals represented by a general formula NaₓM_{y}P₂O_{z} (where M represents at least one transition metal element selected from Fe, Cr, Mn, Co, and Ni, 1.20≤x≤2.10, and 0.95≤y≤1.60) because these types of crystals have excellent cycle characteristics.

The thickness of the positive electrode layer 2 is preferably 20 μm or more, more preferably 50 μm or more, still more preferably 80 μm or more, particularly preferably 100 μm or more, and most preferably 120 μm or more. In this case, the all-solid-state battery 10 can achieve a higher capacity. If the thickness of the positive electrode layer 2 is too large, not only the resistance to electron conduction becomes high to make it likely that the discharge capacity and the operating voltage decrease, but also the stress due to contraction during firing becomes large to make it likely that peel-off occurs. Therefore, the thickness of the positive electrode layer 2 is preferably not more than 150 μm.

The amount of positive-electrode active material contained and supported in the positive electrode layer 2 is preferably 3 mg/cm² or more, more preferably 5 mg/cm² or more, still more preferably 7 mg/cm² or more, particularly preferably 9 mg/cm² or more, and most preferably 12 mg/cm² or more. In this case, the all-solid-state battery 10 can achieve a higher capacity. The upper limit of the amount of positive-electrode active material supported is not particularly limited, but it may be, for example, 100 mg/cm².

As the solid electrolyte layer 1 and the negative electrode layer 3, the same solid electrolyte layer 1 and negative electrode layer 3 as produced in the above-described manufacturing method can be used.

The thickness of the solid electrolyte layer 1 is preferably in a range of 5 μm to 150 μm and more preferably in a range of 20 μm to 200 μm. If the thickness of the solid electrolyte layer 1 is too small, the mechanical strength decreases and, thus, the solid electrolyte layer 1 is liable to breakage. Therefore, an internal short circuit is likely to develop. If the thickness of the solid electrolyte layer 1 is too large, the distance of sodium ion conduction accompanying charge and discharge becomes long and the internal resistance therefore becomes high, so that the discharge capacity and the operating voltage are likely to decrease. In addition, the energy density per unit volume of the all-solid-state battery 10 is also likely to decrease.

Examples of the negative-electrode active material include: crystals containing at least one selected from Nb and Ti, and O; metallic crystals of at least one selected from Sn, Bi, and Sb; and other active material crystals.

The crystals containing at least one selected from Nb and Ti, and O are preferred because they have excellent cycle characteristics. If the crystals containing at least one selected from Nb and Ti, and O further contain Na and/or Li, this is preferred because the charge/discharge efficiency (the proportion of discharge capacity to charge capacity) increases and high charge and discharge capacities can be thus maintained. Particularly, if the crystals containing at least one selected from Nb and Ti, and O are orthorhombic, hexagonal, cubic or monoclinic crystals and, more particularly, if they are monoclinic crystals belonging to space group P21/m, this is more preferred because a capacity decrease is less likely to occur even during charge and discharge at a large current. An example of the orthorhombic crystals is NaTi₂O₄. Examples of the hexagonal crystals include Na₂TiO₃, NaTi₈O₁₃, NaTiO₂, LiNbO₃, LiNbO₂, Li₇NbO₆, LiNbO₂, and Li₂Ti₃O₇. Examples of the cubic crystals include Na₂TiO₃, NaNbO₃, Li₄Ti₅O₁₂, and Li₃NbO₄. Examples of the monoclinic crystals include Na₂Ti₆O₁₃, NaTi₂O₄, Na₂TiO₃, Na₄Ti₅O₁₂, Na₂Ti₄O₉, Na₂Ti₉O₁₉, Na₂Ti₃O₇, Na₂Ti₃O₇, Li_{1.7}Nb₂O₅, Li_{1.9}Nb₂O₅, Li₁₂Nb₁₃O₃₃, and LiNb₃O₈. An example of the monoclinic crystals belonging to space group P21/m is Na₂Ti₃O₇.

The crystals containing at least one selected from Nb and Ti, and O preferably further contain at least one selected from B, Si, P, and Ge. These components have the effect of facilitating the formation of an amorphous phase together with the active material crystals and enhancing the sodium-ion conductivity.

Other negative-electrode active materials that can be used include metallic crystals of at least one selected from Sn, Bi, and Sb, and glasses containing at least one selected from Sn, Bi, and Sb. These materials are preferred because they have high capacity and they are less likely to cause a capacity decrease even during charge and discharge at a large current.

The thickness of the negative electrode layer 3 is preferably in a range of 0.3 μm to 300 μm and more preferably in a range of 3 μm to 150 μm. If the thickness of the negative electrode layer 3 is too small, the absolute capacity (mAh) of the negative electrode tends to decrease. If the thickness of the negative electrode layer 3 is too large, the resistance becomes high, so that the capacity (mAh/g) tends to decrease.

Although the description in the above embodiment has been given of an all-solid-state sodium-ion secondary battery in which a material having sodium-ion conductivity is used, the present invention may be applied to any other all-solid-state battery, such as an all-solid-state lithium-ion secondary battery in which a material having lithium-ion conductivity is used.

In the above embodiment, the electrode layer used in a member for a power storage device is the positive electrode layer 2 made of a sintered body of a positive-electrode material layer 2A containing a positive-electrode active material precursor powder having an average particle diameter of not less than 0.01 μm and less than 0.7 μm. Instead of this, the electrode layer used may be a negative electrode layer 3 made of a sintered body of a negative-electrode material layer containing a negative-electrode active material precursor powder having an average particle diameter of not less than 0.01 μm and less than 0.7 μm, preferably 0.05 μm to 0.6 μm, both inclusive. In this case, the above-described thickness of the positive electrode layer 2 and amount of positive-electrode active material supported may be used as the thickness of the negative electrode layer 3 and the amount of negative-electrode active material supported, respectively. Alternatively, both the positive electrode layer 2 and the negative electrode layer 3 may have these structures.

As necessary, a current collector layer described in relation to the above-described manufacturing method may be formed on each of the positive electrode layer 2 and the negative electrode layer 3.

Hereinafter, the present invention will be described in more detail with reference to specific examples. The present invention is not at all limited to the following examples and can be embodied in appropriately modified forms without changing the gist of the invention.

### Examples 1 to 11 and Reference Examples 1 to 2

(a) Making of Positive-Electrode Active Material Precursor Powder

Using sodium metaphosphate (NaPO₃), iron oxide (Fe₂O₃), and orthophosphoric acid (H₃PO₄) as raw materials, these powdered raw materials were formulated to give a composition of, in terms of % by mole, 40% Na₂O, 20% Fe₂O₃, and 40% P₂O₅ and melted at 1250° C. for 45 minutes in an air atmosphere. Thereafter, the melt was poured between a pair of rotating rollers and formed into a shape with rapid cooling, thus obtaining a film-like glass having a thickness of 0.1 mm to 2 mm. The obtained film-like glass was ground in a ball mill and a planetary ball mill to obtain each of glass powders (positive-electrode active material precursor powders) having respective average particle diameters shown in Table 1. As a result of powder X-ray diffraction (XRD) measurement, all of the obtained glass powders were confirmed to be amorphous.

(b) Making of Solid Electrolyte Layer and Solid Electrolyte Powder

Li₂O-stabilized β″-alumina (manufactured by Ionotec Ltd., composition formula: Na_{1.7}Li_{0.3}Al_{10.7}O₁₇) was processed into a 0.5 mm thick sheet, thus obtaining a solid electrolyte layer. Furthermore, the Li₂O-stabilized β″-alumina in sheet form was ground in a ball mill and a planetary ball mill, thus obtaining a solid electrolyte powder having an average particle diameter of 0.4 μm.

(c) Production of Test Battery

In Examples 1 to 11 and Reference Examples 1 and 2, the positive-electrode active material precursor powder and solid electrolyte powder obtained as above, and acetylene black (SUPER C65 manufactured by TIMCAL) as a conductive carbon were weighed to give each ratio described in Table 1 below and these powders were mixed for 30 minutes with an agate pestle in an agate mortar. An amount of 20 parts by mass of polypropylene carbonate was added to 100 parts by mass of the mixed powder and 30 parts by mass of N-methylpyrrolidinone was further added to the mixture, followed by well stirring with a planetary centrifugal mixer to form a slurry.

The obtained slurry was applied, with an area of 1 cm² and a thickness of 80 μm, to one of the surfaces of the solid electrolyte layer obtained as above and then dried at 70° C. for three hours, thus forming a positive-electrode material layer. In Examples 1 to 11, a carbon sheet (20 mm×20 mm×0.5 mm) was placed on the formed positive-electrode material layer and a weight was further placed on the carbon sheet to apply a pressure shown in Table 1 to the positive-electrode material layer. On the other hand, in Reference Examples 1 and 2, no weight was placed on the positive-electrode material layer.

In this state, the positive-electrode material layer was fired at 525° C. for 30 minutes in a mixed gas of 4% by volume H₂ and 96% by volume N₂ to form a positive electrode layer on the one surface of the solid electrolyte layer, thus producing a member for a power storage device. All the above operations were performed in an environment with a dew point of −40° C. or lower. The amounts of positive-electrode active material supported (the amounts of active material supported) in Examples and Reference Examples are as shown in Table 1 below. The thickness of each electrode layer was measured with a micrometer.

When the powder X-ray diffraction patterns of the obtained positive electrode layers were checked, Na₂FeP₂O₇ crystals were confirmed in all of them. Furthermore, in each of the positive electrode layers, diffraction lines originating from the solid electrolyte powder used were confirmed.

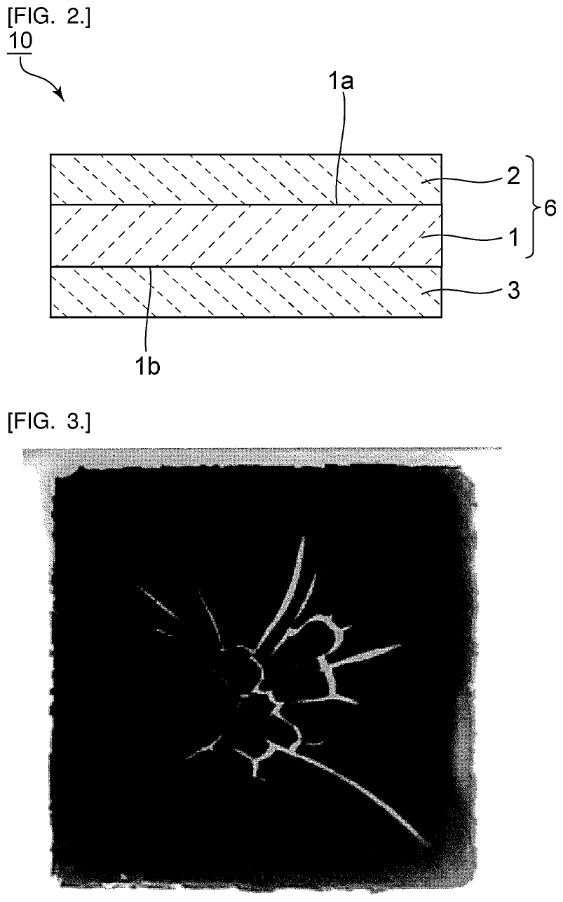

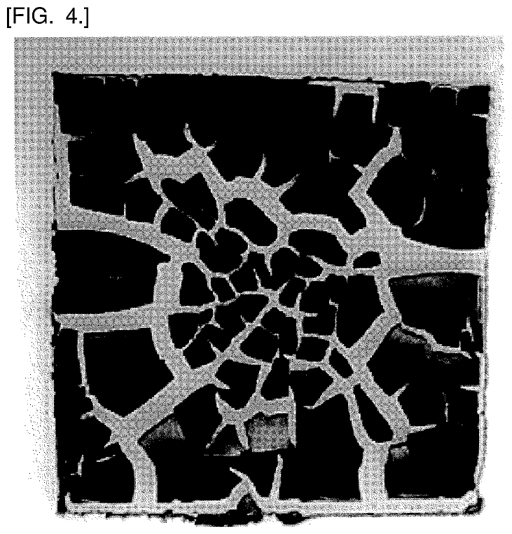

FIG. 3 is a photograph in plan view of a positive electrode layer obtained in Example 5. FIG. 4 is a photograph in plan view of a positive electrode layer obtained in Reference Example 2.

As is obvious from FIG. 3, it can be seen that in Example 5, despite a large amount of positive-electrode active material supported, the positive electrode layer obtained by firing did not peel off from the solid electrolyte layer. Although not shown, also in Examples 1 to 4 and 6 to 11, it was confirmed that, likewise, the positive electrode layer obtained by firing did not peel off from the solid electrolyte layer. Unlike the above, as is obvious from FIG. 4, it was confirmed that in Reference Example 2 the positive electrode layer obtained by firing peeled off from the solid electrolyte layer.

Next, a current collector of a 300-nm thick gold electrode was formed on the surface of each of the obtained positive electrode layers using a sputtering device (item number “SC-701AT” manufactured by Sanyu Electron Co., Ltd.). Thereafter, in an argon atmosphere with a dew point of −60° C. or lower, metallic sodium serving as a counter electrode was pressure-bonded to the other surface of the solid electrolyte layer and the obtained product was placed on a lower lid of a coin cell and covered with an upper lid to produce a CR2032-type test battery.

(d) Charge and Discharge Test

The produced test batteries underwent a charge and discharge test at 30° C. to measure their battery capacities. The results are shown in Table 1. In the charge and discharge test, the C-rate was set at 0.1 C.

TABLE 1

| | | | | | | | | | | | | Ref. | Ref. |
|---|---|---|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 1 | Ex. 2 |
| Positive-electrode | 83 | 83 | 83 | 83 | 83 | 83 | 83 | 83 | 83 | 83 | 83 | 83 | 83 |
| active material | | | | | | | | | | | | | |
| precursor powder | | | | | | | | | | | | | |
| (% by mass) | | | | | | | | | | | | | |
| Solid electrolyte | 13 | 13 | 13 | 13 | 13 | 13 | 13 | 13 | 13 | 13 | 13 | 13 | 13 |
| powder (% by mass) | | | | | | | | | | | | | |
| Conductive carbon | 4 | 4 | 4 | 4 | 4 | 4 | 4 | 4 | 4 | 4 | 4 | 4 | 4 |
| (% by mass) | | | | | | | | | | | | | |
| Average particle | 0.3 | 0.3 | 0.3 | 0.3 | 0.3 | 0.3 | 0.3 | 0.1 | 0.1 | 0.05 | 0.6 | 0.3 | 0.3 |
| diameter of | | | | | | | | | | | | | |
| positive-electrode | | | | | | | | | | | | | |
| active material | | | | | | | | | | | | | |
| precursor powder | | | | | | | | | | | | | |
| (μm) | | | | | | | | | | | | | |
| Amount of active | 3.50 | 7.12 | 4.35 | 3.67 | 7.53 | 9.5 | 13.2 | 3.57 | 4.12 | 3.73 | 5.28 | 3.36 | 7.12 |
| material supported | | | | | | | | | | | | | |
| (mg/cm²) | | | | | | | | | | | | | |
| Thickness of | 23 | 51 | 27 | 22 | 53 | 81 | 121 | 22 | 26 | 24 | 41 | 19 | — |
| positive electrode | | | | | | | | | | | | | |
| layer (μm) | | | | | | | | | | | | | |
| Pressure (kPa) | 30 | 30 | 10 | 90 | 90 | 90 | 90 | 90 | 90 | 90 | 90 | 0 | 0 |
| Mass of weight (g) | 306 | 306 | 102 | 918 | 918 | 918 | 918 | 918 | 918 | 918 | 918 | — | — |
| Appearance | no peel- | no peel- | no peel- | no peel- | no peel- | no peel- | no peel- | no peel- | no peel- | no peel- | no peel- | no peel- | peel- |
| | off | off | off | off | off | off | off | off | off | off | off | off | off |
| Battery capacity | 0.30 | 0.47 | 0.36 | 0.31 | 0.48 | 0.62 | 0.81 | 0.31 | 0.35 | 0.33 | 0.30 | 0.28 | un- |
| (mAh) (0.1 C, 30° | | | | | | | | | | | | | measurable |
| C.) | | | | | | | | | | | | | |

As is obvious from Table 1, it can be seen that the test batteries in Examples 1 to 11 can be charged and discharged regardless of the amount of positive-electrode active material supported. Therefore, it can be seen that, in Examples 2 and 5 to 7 in which the amount of positive-electrode active material supported is large, the battery capacity is increased. Unlike this, it was confirmed that the test battery in Reference Example 2 cannot be charged and discharged.

### REFERENCE SIGNS LIST

1 . . . solid electrolyte layer
1a, 2a . . . first principal surface
1b, 2b . . . second principal surface
2A . . . positive-electrode material layer
2 . . . positive electrode layer
3 . . . negative electrode layer
4 . . . carbon sheet
5 . . . weight
6 . . . member for a power storage device
10 . . . all-solid-state battery

1. A member for a power storage device comprising:
a solid electrolyte layer; and
an electrode layer provided on the solid electrolyte layer and made of a sintered body of an electrode material layer containing an electrode active material precursor powder having an average particle diameter of not less than 0.01 μm and less than 0.7 μm.

2. The member for a power storage device according to claim 1, wherein the electrode layer has a thickness of 20 μm or more.

3. The member for a power storage device according to claim 1, wherein an amount of electrode active material supported in the electrode layer is 3 mg/cm² or more.

4. An all-solid-state battery comprising the member for a power storage device according to claim 1.

5. A method for manufacturing a member for a power storage device, the method comprising:
a forming step of forming an electrode material layer containing an electrode active material precursor powder on a solid electrolyte layer; and
a firing step of firing the electrode material layer while applying pressure to the electrode material layer.

6. The method for manufacturing a member for a power storage device according to claim 5, wherein
the electrode material layer has a first principal surface facing the solid electrolyte layer and a second principal surface opposed to the first principal surface and,
in the firing step, the electrode material layer is fired while pressure is applied to the entire second principal surface.

7. The method for manufacturing a member for a power storage device according to claim 5, wherein in the firing step a pressure of 1 kPa or more is applied to the electrode material layer.

8. The method for manufacturing a member for a power storage device according to claim 5, wherein the electrode active material precursor powder has an average particle diameter of not less than 0.01 μm and less than 0.7 μm.

9. The method for manufacturing a member for a power storage device according to claim 5, wherein the electrode active material precursor powder is an amorphous oxide material.

10. The method for manufacturing a member for a power storage device according to claim 5, wherein the electrode material layer is a positive-electrode material layer.

11. The method for manufacturing a member for a power storage device according to claim 5, wherein the electrode active material precursor powder contains, in terms of % by mole of oxides, 25% to 55% Na₂O, 10% to 30% Fe₂O₃+Cr₂O₃+MnO+CoO+NiO, and 25% to 55% P₂O₅.
